(19) United States
(12) Patent Application Publication
(10) Pub. No.: US 2009/0138557 A1
(43) Pub. Date: May 28, 2009

(54) DELEGATION OF E-MAIL RETURN RECEIPTS

(75) Inventors: Ruthie D. Lyle, Durham, NC (US); Angela Richards Jones, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/945,474

(22) Filed: Nov. 27, 2007

(51) Int. Cl. G06F 15/16

(52) U.S. Cl. 709/206

(57) ABSTRACT

Embodiments of the present invention provide a method, system and computer program product for e-mail return receipt delegation. In an embodiment of the invention, a method for e-mail return receipt delegation can include composing an e-mail message by a sender of the e-mail message, selecting a return receipt for the e-mail message, specifying a delegate for the return receipt other than the sender, and forwarding the e-mail message to an addressed recipient along with a directive designating the delegate to receive the return receipt when the addressed recipient opens the e-mail message. Alternatively, the method can include receiving an e-mail message from a sender of the e-mail message, opening the e-mail message, identifying a request for a return receipt for the e-mail message, locating a delegate for the return receipt other than the sender, and generating and sending a return receipt to the delegate.

### BACKGROUND OF THE INVENTION

1. Field of the Invention

The present invention relates to the field of electronic mail (e-mail) management and more particularly tracking the receipt of sent messages in an e-mail system.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

Oftentimes, it will be important for a sender of an e-mail message to know when a recipient not only receives the e-mail message, but also when the recipient opens the e-mail message. In the latter circumstance, the e-mail message will have been considered “read”. Most commercially distributed e-mail clients provide for a “return receipt” to notice the sender when a sent message has become read. In this regard, the e-mail recipient of a received message can recognize a return-receipt attribute, and upon detecting the opening of the received message, the sender of the received message can be sent a separate e-mail message indicating that the message has been “read”.

Within most commercially distributed e-mail clients, the return-receipt requested attribute can be selected by default such that a return receipt is requested of all outbound e-mail messages. However, there is no flexibility in who is to receive the return receipt. Rather, the sender of the e-mail message always receives the return receipt. Still, in the maddening corporate environment, it can be important that others know when an e-mail is received—not just the sender. In particular, supervisory users and administrative secretarial support users often must know when an e-mail is received. At present, the sender of the e-mail must manually forward a return receipt for an e-mail only once received from the recipient of the e-mail.

### BRIEF SUMMARY OF THE INVENTION

Embodiments of the present invention address deficiencies of the art in respect to e-mail return receipt processing and provide a novel and non-obvious method, system and computer program product for e-mail return receipt delegation. In an embodiment of the invention, a method for e-mail return receipt delegation can be provided. From the perspective of the sender, the method can include composing an e-mail message by a sender of the e-mail message, selecting a return receipt for the e-mail message, specifying a delegate for the return receipt other than the sender, and forwarding the e-mail message to an addressed recipient along with a directive designating the delegate to receive the return receipt when the addressed recipient opens the e-mail message. From the perspective of the recipient, the method can include receiving an e-mail message from a sender of the e-mail message, opening the e-mail message, identifying a request for a return receipt for the e-mail message, locating a delegate for the return receipt other than the sender, and generating and sending a return receipt to the delegate.

In one aspect of the embodiment, forwarding the e-mail message to an addressed recipient along with a directive designating the delegate to receive the return receipt when the addressed recipient opens the e-mail message can include forwarding the e-mail message to an addressed recipient along with a directive designating the delegate to receive the return receipt along with a summary of a status of the e-mail message amongst all addressed recipients when any one of the addressed recipients opens the e-mail message. In another aspect of the embodiment, generating and sending a return receipt to the delegate can include generating and sending a return receipt to the delegate along with a summary of a status of the e-mail message amongst all addressed recipients of the e-mail message.

In another embodiment of the invention, an e-mail messaging data processing system can be provided. The system can include an e-mail server executing in a host server and communicatively coupled to e-mail clients each executing in a respective computing device. The system further can include delegated return receipts logic coupled to the e-mail server. The logic can include program code enabled to select a delegate to receive a return receipt for an e-mail message transmitted from a sender to an addressed recipient, the delegate differing from the sender, and upon detecting an opening of the e-mail message by the addressed recipient, to return a return receipt to the delegate.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for e-mail return receipt delegation;

FIG. 2 is a schematic illustration of an e-mail data processing system configured for e-mail return receipt delegation; and,

FIG. 3 is a flow chart illustrating a process for e-mail return receipt delegation.

### DETAILED DESCRIPTION OF THE INVENTION

Embodiments of the present invention provide a method, system and computer program product for e-mail return receipt delegation. In accordance with an embodiment of the present invention, a user other than a sender of an e-mail message to an addressed recipient can be designated to receive a return-receipt for the e-mail message. Thereafter, in response to the addressed recipient opening the e-mail message, a return receipt can be generated and forwarded to the designated recipient in lieu of or in addition to the sender of the e-mail message. Optionally, along with or as part of the return receipt, a summary can be provided of the status of the e-mail message with all addressed recipients.

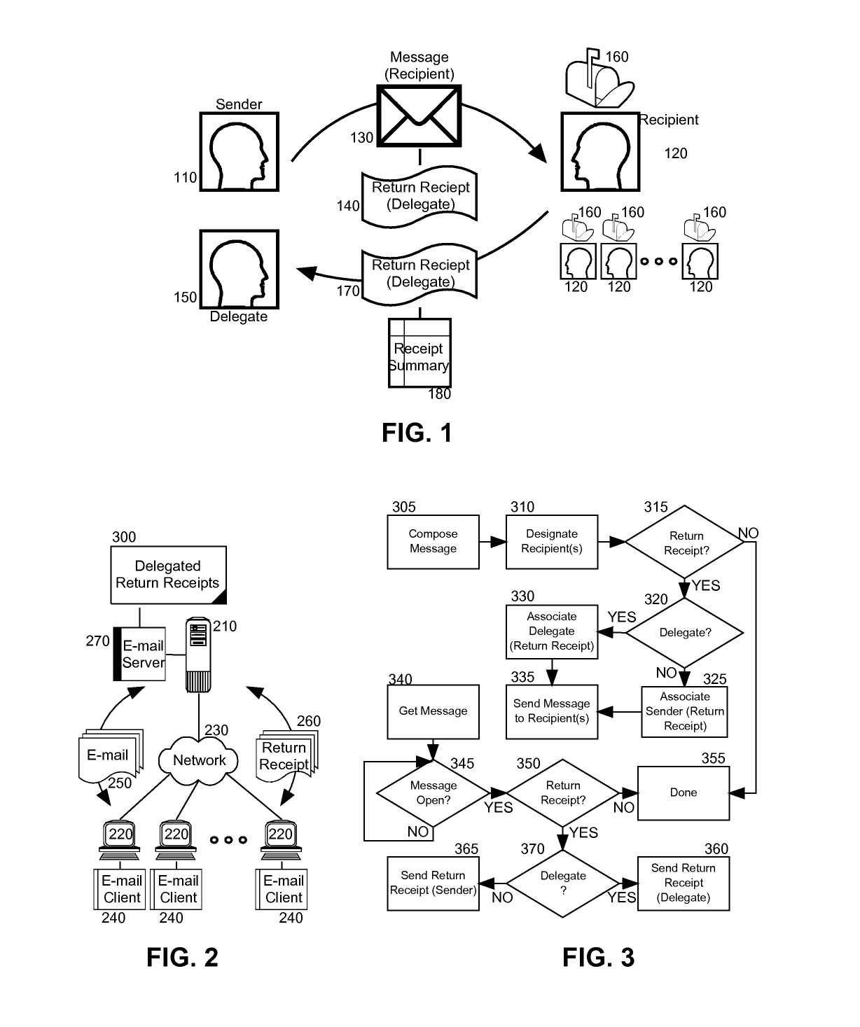

In further illustration, FIG. 1 pictorially depicts a process for e-mail return receipt delegation. As shown in FIG. 1, a sender 110 of an e-mail message 130 can compose and address the e-mail message 130 not only to a recipient 120, but also to one or more other recipients 120, each of the recipients 120 having a corresponding mail box 160 in which e-mail messages can be received, opened and viewed. The e-mail message 130, however, can include a request for return receipt 140. Notably, the request for return receipt 140 can designate at least one delegate 150 to receive a return receipt for the e-mail message 130.

In this way, upon any one of the recipients 120 opening the e-mail message 130, a return receipt 170 can be generated and routed to the designated delegates 150 (only a single one of the delegates 150 shown for the purpose of illustrative simplicity). Yet further, to the extent that multiple recipients 120 have been addressed to receive the e-mail message 130, a receipt summary 180 can be formulated when generating the return receipt 170 indicating a current status of the e-mail message 130 in respect to other ones of the multiple recipients 120. As a result, each of the designated delegates 150 can monitor the progress of receipt of the e-mail message 130 in respect to all of the addressed recipients 120.

The process shown in FIG. 1 can implemented within an e-mail data processing system. In illustration, FIG. 2 schematically shows an e-mail data processing system configured for e-mail return receipt delegation. The system can include a host server 210 configured for communicative coupling to one or more computing devices 220 over computer communications network 230. The host server 210 can support the operation of an e-mail server 270 configured to manage the transmission and receipt of e-mail messages 250 to e-mail clients 240, each hosted in a respective one of the computing devices 220.

Notably, delegated return receipts logic 300 can be coupled to the e-mail server 270. The delegated return receipts logic 300 can include program code enabled to support the delegation of a user other than the sender of the e-mail messages 250 to receive return receipts 260 for the e-mail messages 250. Specifically, for each one of the e-mail messages 250, a sender composing an e-mail message for transmission to a recipient can choose first whether or not a return receipt is to be generated upon opening the composed one of the e-mail messages 250, and second whether a user other than the sender is to receive the return receipt as a delegate for the sender.

In further illustration, FIG. 3 is a flow chart illustrating a process for e-mail return receipt delegation. Beginning in block 305, an e-mail message can be composed for transmission and in block 310 one or more recipients can be designated to receive the e-mail message. In decision block 315, it can be determined whether or not a return receipt is requested by the sender. If not the process can end in block 355, however, if so, in decision block 320 it further can be determined whether or not the recipient of the return receipt is to be delegated to one other than the sender. If not, in block 325 the return receipt can be associated with the sender of the e-mail message. Otherwise, in block 330 the return recipient can be associated with a delegate other than the sender. In either case, the e-mail message can be sent to the addressed recipient.

In block 340, an e-mail message can be received in the inbox of a designated recipient for the e-mail message. In decision block 345, it can be determined whether or not the message has been opened by the designated recipient. If so, in decision block 350 it further can be determined whether or not a return receipt has been requested for the e-mail message. If not the process can end in block 355. However, if so, in decision block 370 it yet further can be determined whether or not the return receipt has been delegated to a user other than the sender of the e-mail message. If not, the return receipt can be routed to the sender in block 365. Otherwise, the return receipt can be routed to the delegate in block 360.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for e-mail return receipt delegation, the method comprising:
composing an e-mail message by a sender of the e-mail message;
selecting a return receipt for the e-mail message;
specifying a delegate for the return receipt other than the sender;
forwarding the e-mail message to an addressed recipient; and,
designating the delegate to receive the return receipt when the addressed recipient opens the e-mail message.

2. The method of claim 1, wherein forwarding the e-mail message to an addressed recipient along with a directive designating the delegate to receive the return receipt when the addressed recipient opens the e-mail message, comprises optionally forwarding the e-mail message to an addressed recipient along with a directive designating the delegate to receive the return receipt along with a summary of a status of the e-mail message amongst all addressed recipients when any one of the addressed recipients opens the e-mail message.

3. A method for e-mail return receipt delegation, the method comprising:
receiving an e-mail message from a sender of the e-mail message;
opening the e-mail message;
identifying a request for a return receipt for the e-mail message;
locating a delegate for the return receipt other than the sender; and,
generating and sending a return receipt to the delegate.

4. The method of claim 1, wherein generating and sending a return receipt to the delegate, comprises generating and sending a return receipt to the delegate along with a summary of a status of the e-mail message amongst all addressed recipients of the e-mail message.

5. An e-mail messaging data processing system comprising:
an e-mail server executing in a host server and communicatively coupled to a plurality of e-mail clients each executing in a respective computing device; and,
delegated return receipts logic coupled to the e-mail server and comprising program code enabled to select a delegate to receive a return receipt for an e-mail message transmitted from a sender to an addressed recipient, the delegate differing from the sender, and upon detecting an opening of the e-mail message by the addressed recipient, to return a return receipt to the delegate.

6. A computer program product comprising a computer usable medium embodying computer usable program code for e-mail return receipt delegation, the computer program product comprising:
computer usable program code for composing an e-mail message by a sender of the e-mail message;
computer usable program code for selecting a return receipt for the e-mail message;
computer usable program code for specifying a delegate for the return receipt other than the sender; and,
computer usable program code for forwarding the e-mail message to an addressed recipient along with a directive designating the delegate to receive the return receipt when the addressed recipient opens the e-mail message.

7. The computer program product of claim 6, wherein the computer usable program code for forwarding the e-mail message to an addressed recipient along with a directive designating the delegate to receive the return receipt when the addressed recipient opens the e-mail message, comprises computer usable program code for forwarding the e-mail message to an addressed recipient along with a directive designating the delegate to receive the return receipt along with a summary of a status of the e-mail message amongst all addressed recipients when any one of the addressed recipients opens the e-mail message.

8. A computer program product comprising a computer usable medium embodying computer usable program code for e-mail return receipt delegation, the computer program product comprising:
computer usable program code for receiving an e-mail message from a sender of the e-mail message;
computer usable program code for opening the e-mail message;
computer usable program code for identifying a request for a return receipt for the e-mail message;
computer usable program code for locating a delegate for the return receipt other than the sender; and,
computer usable program code for generating and sending a return receipt to the delegate.

9. The computer program product of claim 8, wherein the computer usable program code for generating and sending a return receipt to the delegate, comprises computer usable program code for generating and sending a return receipt to the delegate along with a summary of a status of the e-mail message amongst all addressed recipients of the e-mail message.
